(19) United States
(12) Patent Application Publication
(10) Pub. No.: US 2008/0107956 A1
(43) Pub. Date: May 8, 2008

(54) CATALYST USED TO FORM FUEL CELL AND FUEL CELL USING THE SAME

(75) Inventors: Dae-jong Yoo, Yongin-si (KR); Chan-ho Pak, Yongin-si (KR); Hyuk Chang, Yongin-si (KR); Sang-hoon Joo, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/690,341

(22) Filed: Mar. 23, 2007

(30) Foreign Application Priority Data
Sep. 18, 2006 (KR) 2006-90277

(51) Int. Cl. H01M 4/92; B01J 23/14; B01J 23/42; B01J 23/44; B01J 23/46; B01J 23/52; H01M 4/88; H01M 4/90

(52) U.S. Cl. 429/41; 502/300; 502/325; 502/339; 502/344; 502/352

(57) ABSTRACT

A catalyst, a method of preparing the catalyst, and a fuel cell using the catalyst. The catalyst includes a catalyst metal particle, and a porous coating layer of a conductive ceramic material disposed on the surface of the catalyst metal particle. The catalyst has a methanol tolerance index of 80%, or more, a smaller particle size than a commercially available Pt-black catalyst manufactured through a polyol process. The catalyst can include a PT catalyst metal particle that is surface treated, or coated, with a conductive ceramic ATO. The catalyst has an excellent ORR activity in the presence of methanol, and an enhanced tolerance with respect to methanol. A fuel cell, including an electrode manufactured using the catalyst, has a high energy density and a high fuel efficiency.

### CROSS-REFERENCE TO RELATED APPLICATIONS

This application claims the benefit of Korean Application No. 2006-90277, filed Sep. 18, 2006, in the Korean Intellectual Property Office, the disclosure of which is incorporated herein by reference.

### BACKGROUND OF THE INVENTION

1. Field of the Invention

Aspects of the present invention relate to a catalyst used in a fuel cell, and a fuel cell using the catalyst, and more particularly to a catalyst having a high efficiency obtained by surface treating a catalyst metal particle.

2. Description of the Related Art

Fuel cells are a potential clean energy source which can replace fossil fuels, and have a high current density and energy conversion capability. In addition, they are operable at room temperature, can be miniaturized, can be hermetically fabricated, and thus, are widely applicable in the automobile industry, home power generation systems, mobile communications equipment, medical devices, military equipment, aerospace equipment, and the like.

Direct methanol fuel cells (DMFCs) use a liquid fuel, and are operable at room temperature. Due to these advantages, DMFCs can be produced in small sizes, and used as a power source for portable devices.

However, the phenomenon of methanol cross-over decreases the performance of a DMFC system and the stability of a cathode catalyst. Therefore, there is a need to develop a catalyst which shows excellent oxygen reducing reactivity, and does not react with methanol, that is, tolerates methanol.

For example, a catalyst having high activity and high durability can be produced by using Pt or a Pt-group catalyst, for example, a catalyst having an Fe or Co core and a Pt-group metal as a shell (see US 20050075240A1). In addition, a method in which a PtRu catalyst is coated with silica and then the coated PtRu catalyst is supported by carbon, in order to improve the durability of a catalyst, is disclosed (see P2005-276688A)

However, catalysts produced using conventional methods have excessively large particles, and have a low metal loading in a supporting catalyst. As a result, such catalysts cannot be used in a DMFC. Accordingly, there is a need to develop a catalyst having the higher activities of an ORR and a tolerance for methanol.

### SUMMARY OF THE INVENTION

Aspects of the present invention provide a catalyst used to form a fuel cell having high efficiency and a tolerance for methanol, and a method of producing the same.

Aspects of the present invention also provide an electrode including the catalyst, and a fuel cell having a high fuel efficiency and a high energy density, and including the electrode.

According to an aspect of the present invention, there is provided a catalyst used to form a fuel cell, wherein the catalyst includes a catalyst metal particle, and a porous coating layer containing a ceramic material formed on the surface of the catalyst metal particle, wherein the methanol tolerance index of the catalyst is 80%, or more.

According to another aspect of the present invention, there is provided a method of preparing a catalyst used to form a fuel cell, wherein the method includes: mixing a catalyst metal precursor with a first solvent, to obtain a catalyst metal precursor-containing mixture; mixing a second solvent with a base, to obtain a base solution; mixing the catalyst metal precursor-containing mixture with the base solution to obtain a first mixture, and then heating and cooling the first mixture, thereby obtaining a catalyst metal colloid; mixing Sn and Sb precursors with a third solvent, to obtain an Sn and Sb precursor-containing mixture; and mixing the catalyst metal colloid with the Sn and Sb precursor-containing mixture to obtain a second mixture, and then heating, washing, filtering, and drying the second mixture.

According to another aspect of the present invention, there is provided an electrode used to form a fuel cell including the catalyst.

According to another aspect of the present invention, there is provided a fuel cell including an electrode including the catalyst.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates the structure of a catalyst used to form a fuel cell according to an embodiment of the present invention;

FIG. 2 is a flow chart illustrating a method of preparing a catalyst according to an embodiment of the present invention;

FIG. 3 is a schematic view of a fuel cell according to an embodiment of the present invention;

FIG. 4 is a graph illustrating the results of an X-ray diffraction analysis of catalysts prepared according to Examples 1-3, and Comparative Example 1;

FIG. 5 includes transmission electron microscope (TEM) micrographs of catalysts prepared according to Examples 1-3, and Comparative Example 1;

FIG. 6A and FIG. 6B illustrate the results of a half cell test performed on catalysts prepared according to Examples 1-3, and Comparative Example 1; and

FIG. 7 is a graph illustrating the results of an air breathing passive cell test performed on catalysts prepared according to Example 1, and Comparative Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

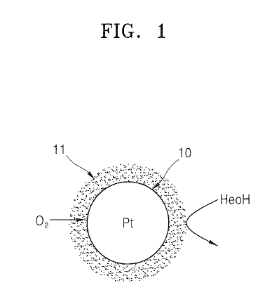

A catalyst used to form a fuel cell, according to an embodiment of the present invention as illustrated in FIG. 1, includes a catalyst metal particle 10, such as a Pt particle, and a porous coating layer 11 formed by surface treating or coating the catalyst metal particle 10 with a conductive ceramic. The conductive ceramic is impermeable to methanol but is permeable to oxygen. The catalyst, including the porous coating layer, has a methanol tolerance index of 80%, or more.

The term of “methanol tolerance index” used by the applicant in the present application will now be described in detail.

The methanol tolerance index can be represented by Formula 1:

Methanol tolerance index=(ORR @0.75V in methanol)/(ORR @0.75V in acid)×100;

The ORR @0.75V in methanol represents a current value per unit weight of a catalyst (A/g), at 0.75 V, in a cathode of a DMFC that operates by performing voltage scanning using cyclic voltammetry, after a 0.1M HClO₄ solution, and a 0.1M methanol solution, are saturated with dissolved O₂ by purging with O₂. The ORR @0.75V in acid represents a current value per unit weight of a catalyst (A/g), at 0.75 V, in a cathode of a DMFC that operates by performing voltage scanning using a cyclic voltammetry, after a 0.1M HClO₄ solution is purged with O₂, to saturate the solution with dissolved oxygen.

In Formula 1, the ORR @0.75V represents a cathode operating condition of a fuel cell. For example, ORR @0.75V represents a cathode operating in the range of from 0.6 to 0.8V, and in particular, 0.75V.

When the methanol tolerance index is high, the catalyst has high reactivity with respect to oxygen, and low reactivity with respect to methanol. An ideal cathode catalyst for a direct methanol fuel cell may have a methanol tolerance index of 100%. As a reference, a Pt-black catalyst has a methanol tolerance index of 69%.

According to an embodiment of the present invention, the methanol tolerance index may be 80%, or more, and in particular, in the range of from 80 to 95%.

The porous conductive ceramic allows the passage of oxygen, so that the oxygen can react with the catalyst metal catalyst, but physically blocks methanol.

The catalyst according to an embodiment of the present invention can be used as an electrode catalyst for a fuel cell which tolerates methanol, in particular, as a cathode catalyst.

In the catalyst according to an embodiment of the present invention, the catalyst can comprise catalyst metal particles in the amount of from 60 to 90 parts by weight, based on 100 parts by weight of the catalyst. The catalyst metal particles can have an average particle diameter of less than 5 nm, and in particular, an average diameter in the range of from 2.5 to 4.5 nm. When the amount of the catalyst metal particles is less than 60 parts by weight, the porous ceramic layer is so thick that the catalyst does not have a significant ORR activity. On the other hand, when the amount of the catalyst metal particles is greater than 90 parts by weight, the porous ceramic layer insufficiently coats the catalyst metal particle, so that the catalyst may not sufficiently tolerate methanol. As such, catalyst metal particles having an average diameter of less than 5 nm, exhibit decreased catalytic activity.

The catalyst metal particle may include at least one metal selected from the group consisting of Pt, Ru, Pd, Rh, Ir, Os, and Au. For example, the catalyst can be Pt or a Pt alloy.

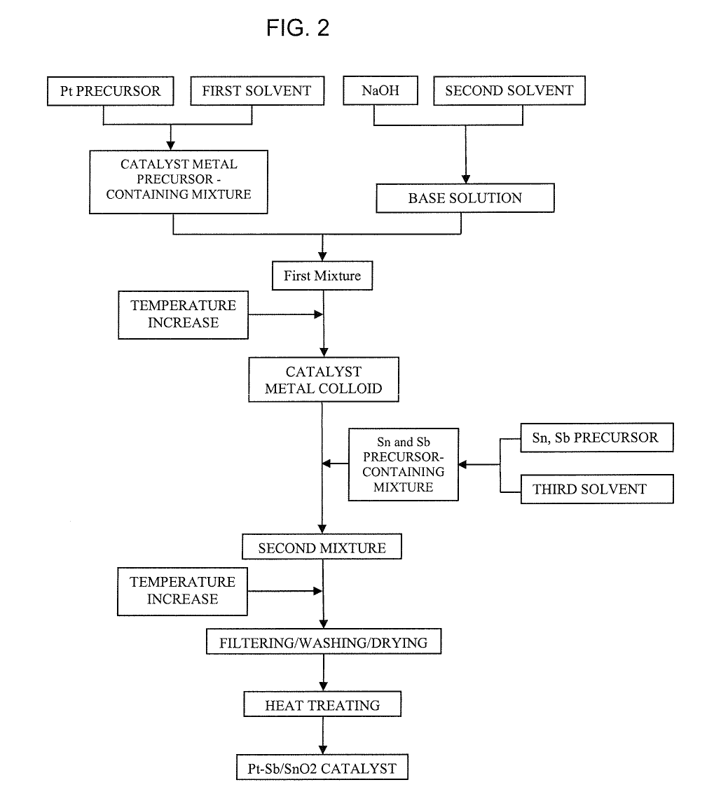

Referring to FIG. 2, a method of preparing a catalyst according to an embodiment of the present invention, and process variations used in the method, will now be described in detail. In FIG. 2, a Pt precursor acts as a catalyst metal precursor, and NaOH acts as a base.

In the method, a catalyst metal colloid is prepared through a polyalcohol process, and then a Sb/Sn salt is reacted with the surface of the catalyst metal particle so that the catalyst metal particle is coated with a porous coating layer formed of antimony doped tin oxide (ATO). This process in the method will now be described in detail.

A catalyst metal precursor is dissolved in a first solvent, to prepare a catalyst metal precursor-containing mixture. The first solvent can be a polyalcohol, such as ethyleneglycol, diethyleneglycol, or triethyleneglycol. The amount of the catalyst metal precursor may be in the range of from 1 to 1.8 parts by weight, or in a range of from 1.1 to 1.6 parts by weight, based on 100 parts by weight of the entire solvent. At this time, the weight of the entire solvent represents the sum of weights of the first solvent that is used to dissolve the catalyst metal precursor, and a second solvent that is used to dissolve a base. When the amount of the catalyst metal precursor is less than 1.1 parts by weight, so much entire solvent is present with respect to the catalyst metal particle, that the catalyst metal particles in the colloid are reduced in size to the point where the catalyst metal particles aggregate. On the other hand, when the amount of the catalyst metal precursor is greater than 1.6 parts by weight, the size of the colloid particles in the solution significantly increases.

Among catalyst metal precursors described above, a Pt precursor can be H₂PtCl₄, H₂PtCl₆, K₂PtCl₄, K₂PtCl₆, or a mixture thereof; an Ru precursor can be (NH₄)₂[RuCl₆] or (NH₄)₂[RuCl₅H₂O]; and an Au precursor can be H₂-[AuCl₄], (NH₄)₂[AuCl₄], or H[Au(NO₃)₄]H₂O.

An alloy catalyst can be obtained by using a precursor mixture having a mixture ratio corresponding to a desired atomic ratio of the selected metals.

A base is dissolved in a second solvent to obtain a base solution. The base can be NaOH, KOH, NH₄OH, or a mixture thereof, and the second solvent can be water.

The amount of the second solvent may be in the range of from 6 to 14 parts by weight, based on 100 parts by weight of the entire solvent. When the amount of the second solvent is less than 6 parts by weight, a porous ceramic may not be formed, due to lack of water. On the other hand, when the amount of the second solvent is greater than 14 parts by weight, the porous ceramic particle is rapidly formed, and thus, it is difficult to produce a uniform porous ceramic coating on the catalyst metal particle. The amount of the base may be in the range of from 0.01 to 0.09 parts by weight, based on 100 parts by weight of water acting as the second solvent. When the amount of the base is greater than 0.09 parts by weight, an oxide material can be formed when the metal salt is reduced. On the other hand, when the amount of the base is less than 0.01 parts by weight, the colloid material tends not to aggregate, so a solid phase may not be obtained.

The catalyst metal precursor-containing mixture is mixed with the base solution to obtain a first mixed solution. The first mixed solution is heated and cooled to prepare a catalyst metal colloid. At this time, the heating may be performed at a temperature of from 70 to 120° C., and the cooling may be performed at room temperature (25° C.).

When the first mixed solution is heated at less than 70° C., the colloid metal particle is incompletely reduced. On the other hand, when the first mixed solution is heated at more than 120° C., the colloid metal particle is rapidly reduced, which can lead to the aggregation of the colloid particles.

In the catalyst metal colloid, the amount of the catalyst metal particle may be in the range of from 0.44 to 0.64 parts by weight, based on 100 parts by weight of the catalyst metal colloid.

In the catalyst metal colloid, the size and stability of the catalyst metal particle may depend on the amount of the entire solvent, the amount of water acting as the second solvent, and the amount of the base.

An Sn precursor and an Sb precursor are mixed with a third solvent, to prepare an Sn precursor and Sb precursor-containing mixture.

The Sn precursor can be SnCl₂.2H₂O or SnCl₅.5H₂O, and the Sb precursor can be SbCl₃. The third solvent can be a polyalcohol which can also be used as the first solvent. Examples of suitable polyalcohols have been described above.

The amount of the Sn precursor may be in the range of from 1 to 16 parts by weight, based on 100 parts by weight of the catalyst metal precursor. The amount of the Sb precursor may be in the range of from 10 to 12 parts by weight of the Sn precursor. When the amounts of the Sn precursor and the Sb precursor are less than their respective lower limits, the ATO coating layer which covers the catalyst metal particle, such as a Pt particle, is so thick that activity of the catalyst may decrease. On the other hand, when the amounts of the Sn precursor and the Sb precursor are greater than respective upper limits, the catalyst metal particle, such as Pt particle, is only partially coated with the ATO coating layer such that the catalyst may not tolerate methanol.

The amount of the third solvent may be in the range of from 400 to 3000 parts by weight, based on 100 parts by weight of the total weight of the Sn precursor and the Sb precursor.

The catalyst metal colloid is mixed with the Sn precursor and Sb precursor-containing mixture, and then the resulting mixture is heated, washed, filtered, and dried. The drying may be freeze drying. The heating may be performed at a temperature of from 115 to 145° C., or at a temperature of from 125 to 135° C.

When the mixture is heated to a temperature that is greater than 145° C., the porous ceramic may rapidly react with the surface of the metal catalyst particle, during the surface coating process, so that a uniform coating cannot be obtained. On the other hand, when the heating temperature is lower than 115° C., the porous ceramic may have a low reactivity when the metal catalyst particle is surface coated, such that the reducing reaction is incomplete.

A catalyst including a porous coating layer as illustrated in FIG. 1, can be obtained using the method described above. In the catalyst, the amount of the catalyst metal particles may be in the range of from 60 to 90 parts by weight, based on 100 parts by weight of the catalyst. The catalyst may have an average particle diameter of 5 nm, or less. The amount of the catalyst metal particle and the average particle diameter of the catalyst, are closely related to activity of the catalyst, and to the tolerance of the catalyst with respect to methanol.

The catalyst prepared as described above can be used in an electrode catalyst layer of a fuel cell, in particular, in a cathode catalyst layer, which has the ability to tolerate methanol. The fuel cell can be a direct methanol fuel cell.

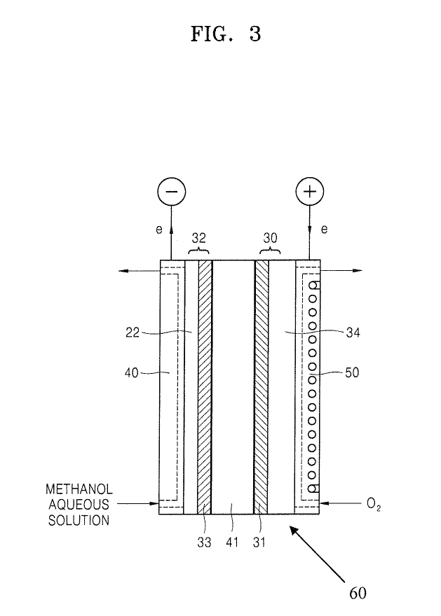

In FIG. 3, a fuel cell including the catalyst according to an embodiment of the present invention is depicted. In particular, a direct methanol fuel cell (DMFC), according to an embodiment of the present invention is depicted, and will now be described in detail.

Referring to FIG. 3, a DMFC 60 includes an anode 32 to which a fuel is supplied, a cathode 30 to which an oxidant is supplied, and an electrolyte membrane 41 between the anode 32 and the cathode 30. In general, the anode 32 includes an anode diffusion layer 22 and an anode catalyst layer 33. The cathode 30 includes a cathode diffusion layer 34 and a cathode catalyst layer 31. The anode catalyst layer 33 and the cathode catalyst layer 31, used in the present embodiment, are formed of the Pt-black catalyst described above.

A separator 40 includes flow channels through which a fuel is supplied to the anode 32, and acts as an electric conductor which transports electrons generated at the anode 32 to an external circuit, or an adjacent unit cell. A separator 50 includes holes through which an oxidant is supplied to the cathode 30, in an air-breathing cathode, and acts as an electric conductor which transports electrons supplied from an external circuit, or an adjacent unit cell, to the cathode 30. In the DMFC 60, the fuel supplied to the anode 32 can be a methanol aqueous solution, and the oxidant supplied to the cathode 30 can be air.

A methanol aqueous solution flows to the anode catalyst layer 33, through the anode diffusion layer 22, and decomposes into electrons, hydrogen ions, and carbon dioxide. The hydrogen ions move to the cathode catalyst layer 31 by moving through an electrolyte membrane 41. The electrons move through an external circuit, and the carbon dioxide is externally discharged. In the cathode catalyst layer 31, the hydrogen ions transported through the electrolyte membrane 41, the electrons supplied from the external circuit, and oxygen from the air transported through the cathode diffusion layer 34, are reacted to generate water.

In the DMFC 60, the electrolyte membrane 41 acts as a hydrogen ion conductor, an electron insulator, and a separator. In particular, the electrolyte membrane 41 can act as a separator because it can prevent the flow of un-reacted fuel to the cathode 30, and/or prevent the flow of un-reacted fuel to the anode 32.

The electrolyte membrane 41 of the DMFC 60 can be formed of a cationic exchange polymer electrolyte, such as, a sulfonized perfluoro polymer (NAFION produced by Dupont Co.) having a back bone of alkylene and a side chain of a sulfonic acid group-terminated sulfonized vinyl ether.

The present invention will be described in further detail with reference to the following examples. These examples are for illustrative purposes only and are not intended to limit the scope of the present invention.

### Example 1

2.3554 g of H₂PtCl₆.xH₂O(UMICORE, 39.8 wt % of Pt), acting as a Pt precursor, was dissolved in 162 g of ethylene glycol, to prepare a Pt precursor-containing mixture.

Separately, 1 g of NaOH was mixed with 18 g of water, to obtain an NaOH aqueous solution.

The Pt precursor-containing mixture was mixed with the NaOH aqueous solution. The temperature of the mixture was ramped up to 90° C., over 0.5 h, and then maintained at 90° C. for 2 h. As a result, a Pt colloid was obtained.

0.25 g of SnCl₂.2H₂O and 0.03 g of SbCl₃ were mixed with 10 g of ethylene glycol, to prepare an Sn precursor and Sb precursor-containing mixture. The Sn precursor and Sb precursor-containing mixture was mixed with a Pt colloidal mixture. The temperature of resulting mixture was ramped up to 90° C., over 0.5 h, and then maintained at 90° C. for 2 h. The temperature was then, ramped up to 135° C., over 0.5 h, and then maintained at 135° C. for 2 h.

The resulting heated mixture was washed several times, and dried in a freeze dryer. As a result, a Pt/Sb—SnO₂ catalyst was obtained.

A method of manufacturing a fuel cell using a catalyst layer formed of the Pt/Sb—SnO₂ catalyst will now be described in detail.

An anode was formed using 5 mg/cm² of PtRu-black (JM600) A cathode was formed using 5 mg/cm² of the Pt/Sb—SnO₂ catalyst (based on the entire catalyst), using a catalyst coated membrane (CCM) method, that is, using a NAFION membrane 115 and a decal process, to produce a CCM-type layered catalyst

Subsequently, the CCM-type layered catalyst was assembled with an anode diffusion layer and a cathode diffusion layer, at 125° C. and a pressure of 3 tons, for three minutes, to prepare a membrane and electrode assembly (MEA). Typically, an MEA is structured such that a catalyst layer and an electrode are sequentially deposited on both side of a hydrogen ion conductive polymer membrane.

A separator to supply a fuel was attached to the anode, and a separator to supply an oxidant was attached to the cathode. As a result, a fuel cell was manufactured.

### Examples 2 and 3

A catalyst and a fuel cell were manufactured in the same manner as in Example 1, except that the amounts of the entire solvent, water, and NaOH were changed as shown in Table 1.

### Comparative Example 1

A fuel cell was manufactured in the same manner as in Example 1, except that a Pt-black catalyst (JM1000), which is commercially available from John & Matthey PLC, was used as a cathode catalyst and an anode catalyst.

Table 1 shows the amounts of the entire solvent, water, NaOH, and Pt particles (using ICP), used in the manufacturing methods for the catalysts prepared according to Examples 1-3.

TABLE 1

| | Amount | | | | | | |
|---|---|---|---|---|---|---|---|
| | of | Amount | Amount | | | | |
| | Entire | of | of | | | | |
| | Solvent | NaOH | Water | ICP-AES (wt %) | | | |
| | (g) | (g) | (wt %) | Pt | Sn | Sb | O |
| Examples 1 | 180 | 1 | 10 | 76.54 | 10.57 | 1.11 | 11.78 |
| Examples 2 | 210 | 1.2 | 6 | 76.51 | 10.68 | 1.26 | 11.55 |
| Examples 3 | 180 | 1 | 10 | 83.27 | 6.96 | 0.83 | 8.94 |

| | | | | | |
|---|---|---|---|---|---|
| Comparative | Pt-black (JM600) | 99 | — | — | 1 |
| Example 1 | | | | | |

In Table 1, the Amount of Entire Solvent represents the sum of the amount of ethyleneglycol used to prepare the Pt precursor solution, the amount of water used to prepare the NaOH solution, and the amount of ethylene glycol used to prepare the Sn precursor and Sb precursor-containing mixture. The Amount of Water represents the weight of water, based on 100 parts by weight of the sum of the ethylene glycol and water, and the Amount of NaOH represents the weight of the NaOH.

As illustrated in Table 1, in order to obtain a Pt/Sb—SnO₂ catalyst that tolerates methanol and reduces oxygen, the amount of Pt was about 80 parts by weight, and 20 parts by weight of the Sb—SnO₂ material, was coated on the surface of the Pt.

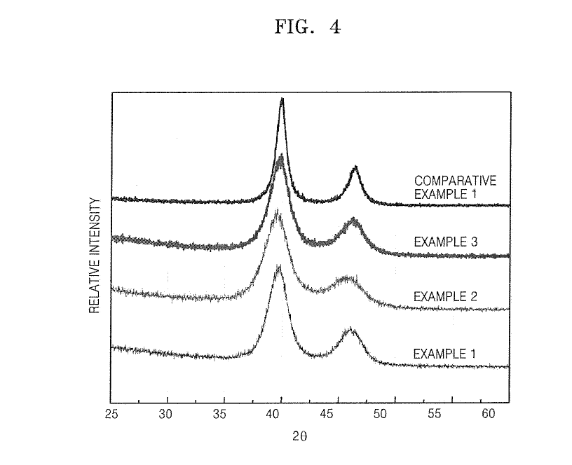

An X-ray diffraction analysis of the catalysts, prepared according to Examples 1-3 and Comparative Example 1, was performed. The results are shown in FIG. 4 and Table 2.

TABLE 2

| | | | | Comparative |
|---|---|---|---|---|
| | Examples 1 | Examples 2 | Examples 3 | Example 1 |
| Average | 4.44 | 3.47 | 4.24 | 7.9 |
| Diameter | | | | |
| of Catalyst | | | | |
| Particle | | | | |
| (nm) | | | | |

As illustrated in Table 2, the catalysts prepared according to Examples 1-3 had smaller average particle diameters than the catalyst prepared according to Comparative Example 1.

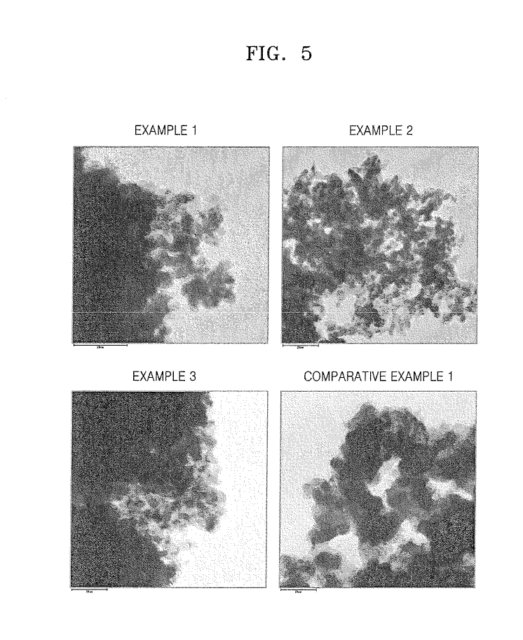

A transmission electron microscopy (TEM) analysis was performed using the catalysts prepared according to Examples 1-3 and Comparative Example 1. The results are shown in FIG. 5 and Table 3.

TABLE 3

| | | | | Comparative |
|---|---|---|---|---|
| | Examples 1 | Examples 2 | Examples 3 | Example 1 |
| Average | 2.71 | 2.56 | 3 | 12 |
| Diameter | | | | |
| of Catalyst | | | | |
| Particle | | | | |
| (nm) | | | | |

As illustrated in Table 3, the catalysts prepared according to Examples 1-3 had much smaller average particle diameters than the catalyst prepared according to Comparative Example 1.

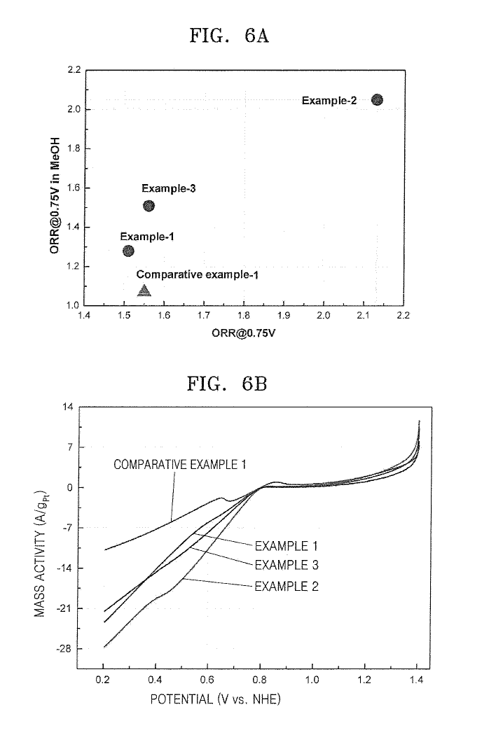

A half cell test was performed using the catalysts prepared according to Examples 1-3 and Comparative Example 1, a cyclic voltammetry analysis was performed to measure the ORR@0.75V in acid and the ORR@0.75V in methanol, and the mass activity was measured. The results are shown in FIG. 6A, FIG. 6B, and Table 4. The ORR@0.75V in acid and the ORR@0.75V in methanol are defined above.

The half-cell test was performed according to a potentiostat/galvanostat method, and the mass activity represents the current value per a unit weight, at a constant voltage.

TABLE 4

| | Half Cell | | |
|---|---|---|---|
| | | ORR(A/g) in | Methanol Tolerance |
| | ORR(A/g) in acid | Methanol | Index |
| Examples 1 | 1.51 | 1.28 | 84.7 |
| Examples 2 | 2.13 | 2.05 | 96.2 |
| Examples 3 | 1.56 | 1.52 | 97.4 |
| Comparative | 1.55 | 1.07 | 69 |
| Example 1 | | | |

Referring to Table 4, the methanol tolerance indexes, of the catalysts prepared according to Examples 1-3, were 84.7, 96.2, and 97.4, respectively, whereas the methanol tolerance index of the catalyst prepared according to Comparative Example 1 was 69. That is, the catalysts prepared according to Examples 1-3 showed lower reactivity with respect to methanol than the catalyst prepared according to Comparative Example 1.

Referring to FIG. 6A and FIG. 6B, in case of the catalyst prepared according to Comparative Example 1, the ORR in acid was lower than the ORR in methanol; whereas, in case of the catalyst prepared according to Examples 1, 2, and 3, the ORR in acid was the same as the ORR in methanol. Therefore, the catalysts of examples 1, 2, and 3 show a good methanol tolerance.

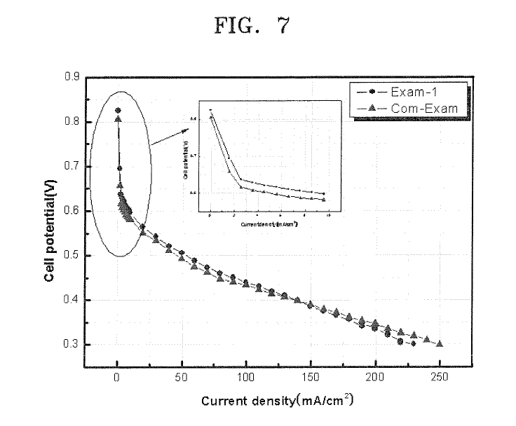

An air breathing passive cell test was performed using the catalysts prepared according to Example 1 and Comparative Example 1. In particular, through the air breathing passive cell test, the performance of the unit cells, prepared according to Example 1 and Comparative Example 1, was measured. 0.14 ml/min of a 1M methanol aqueous solution was used as a fuel, 52.5 ml/min of air was used as an oxidant, and the operation temperature was 50° C. The test results are shown in FIG. 7 and Table 5.

TABLE 5

| | Unit Cell (1M, 0.35 V) Air Breathing |
|---|---|
| | 50° C. (mW/cm²) |
| Examples 1 | 65 |
| Comparative Example 1 | 67 |

Referring to Table 5, the fuel cells prepared according to Example 1 and Comparative Example 1 showed similar levels of performance. However, referring to FIG. 7, at a low current density of 10 mA/cm², or less, which relates to the activity of a catalyst, the fuel cell prepared according to Example 1 showed a higher performance than the fuel cell prepared according to Comparative Example 1. At a high current density, which relates to mass transfer, the fuel cells prepared according to Example 1, and Comparative Example 1, showed similar levels of performance.

A catalyst, according to aspects of the present invention, has a smaller average particle size than a commercially available Pt black catalyst manufactured through a polyol process. Such a catalyst includes a catalyst metal particle, such as Pt, which is surface treated, or coated, with a conductive ceramic ATO, so that the catalyst has an excellent ORR activity in the presence of methanol, and an enhanced tolerance with respect to methanol. A fuel cell, including an electrode manufactured using the catalyst, has a high energy density and a high fuel efficiency.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A catalyst used to form a fuel cell, the catalyst comprising:
a catalyst metal particle having a methanol tolerance index; and
a porous coating layer, comprising a conductive ceramic material, disposed on the surface of the catalyst metal particle,
wherein the methanol tolerance index of the catalyst is 80% or more.

2. The catalyst of claim 1, wherein the conductive ceramic material comprises antimony doped tin oxide (ATO).

3. The catalyst of claim 1, wherein
the amount of the catalyst metal particle is in the range of from 60 to 90 parts by weight, based on 100 parts by weight of the catalyst, and
the average diameter of the catalyst metal particle is less than 5 nm.

4. The catalyst of claim 1, wherein the catalyst metal particle comprises at least one metal selected from the group consisting of Pt, Ru, Pd, Rh, Ir, Os, and Au.

5. A method of preparing a catalyst for a fuel cell, the method comprising:
mixing a catalyst metal precursor with a first solvent to obtain a catalyst metal precursor-containing mixture;
mixing a second solvent with a base to obtain a base solution;
mixing the catalyst metal precursor-containing mixture with the base solution to obtain a first mixture;
heating and cooling the first mixture, to obtain a catalyst metal colloid;
mixing an Sn precursor and an Sb precursor with a third solvent to obtain an Sn and Sb precursor-containing mixture; and
mixing the catalyst metal colloid with the Sn and Sb precursor-containing mixture to obtain a second mixture; and
heating, washing, filtering, and drying the second mixture to obtain the catalyst.

6. The method off claim 5, wherein the amount of the catalyst metal precursor is in the range of from 1.1 to 1.6 parts by weight, based on 100 parts by weight of the catalyst metal precursor-containing mixture.

7. The method off claim 5, wherein the base comprises at least one base selected from the group consisting of NaOH, KOH, and NH₄OH.

8. The method off claim 5, wherein the amount of the second solvent is in the range of from 6 to 14 parts by weight, based on 100 parts by weight of the first and second solvents.

9. The method off claim 5, wherein the amount of the Sn precursor is in the range of from 1 to 16 parts by weight, based on 100 parts by weight of the catalyst metal precursor.

10. The method off claim 5, wherein the amount of the base is in the range of from 0.01 to 0.09 parts by weight, based on 100 parts by weight of the second solvent.

11. The method off claim 5, wherein the first solvent and the third solvent are polyalcohols, and the second solvent is water.

12. The method off claim 5, wherein the heating of the first mixture is performed at a temperature of from 70 to 120° C.

13. The method off claim 5, where in the heating of the second mixture is performed at the temperature of from 125 to 135° C.

14. An electrode for a fuel cell, wherein the electrode comprises the catalyst of claim 1.

15. The electrode of claim 14, wherein the electrode is a cathode.

16. A fuel cell, comprising:
an anode;
a cathode; and
an electrolyte membrane disposed between the anode and the cathode,
wherein the cathode comprises a catalyst comprising a catalyst metal particle coated with a conductive ceramic material,
wherein the catalyst has a methanol tolerance index of 80% or more.

17. The fuel cell of claim 16, wherein the conductive ceramic material is antimony doped-tin oxide (ATO).

18. The fuel cell of claim 16, wherein the amount of the catalyst metal particle is in the range of from 60 to 90 parts by weight, based on 100 parts by weight of the catalyst, and
the average diameter of the catalyst metal particle is less than 5 nm.

19. The fuel cell of claim 16, wherein the catalyst metal particle of the cathode comprises at least one metal selected from the group consisting of Pt, Ru, Pd, Rh, Ir, Os, and Au.

20. The method of claim 5, wherein the Sb precursor is SbCl₃.

21. The method off claim 5, wherein the heating of the second mixture comprises heating at a temperature of from 115 to 145° C.

22. The method of claim 5, wherein the heating and cooling of the first mixture comprises heating the first mixture to a temperature of from 70 to 120° C., and then cooling the mixture at room temperature.

23. The method of claim 5, wherein the drying of the second mixture comprises freeze drying.

24. The method of claim 5, wherein the catalyst metal precursor is selected from the group consisting of H₂PtCl₄, H₂PtCl₆, K₂PtCl₄, K₂PtCl₆, and a mixture thereof.

25. The method of claim 5, wherein the heating of the first mixture comprises increasing the temperature of the first mixture, over the course of about 0.5 h, to a temperature of from 70 to 120° C.

26. The method of claim 25, wherein the heating of the first mixture further comprises maintaining the temperature of from 70 to 120° C. for about 2 h.
